(19) United States
(12) Patent Application Publication
(10) Pub. No.: US 2002/0071212 A1
(43) Pub. Date: Jun. 13, 2002

(54) Protected data storage cards

(76) Inventor: Robert R. Rogers, Newport Beach, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/968,677

(22) Filed: Oct. 1, 2001

Related U.S. Application Data
(60) Provisional application No. 60/236,779, filed on Sep. 29, 2000.

(51) Int. Cl. G11B 23/02; G11B 23/03

(52) U.S. Cl. 360/132; 360/133

(57) ABSTRACT

Small, easily transportable data storage cards in which the stored data is protected against external contamination. The structure of the cards provides two positions, a first position for sequestering the data, and a second position allowing physical access to the stored data during the writing and/or reading thereof.

### PRIORITY CLAIM

The application claims the benefit of U.S. provisional application No. 60/236,779, filed Sep. 29, 2001, entitled “Protected Data Storage Cards.”

### FIELD OF THE INVENTION

This invention relates to high density data storage cards and protection for such cards.

### SUMMARY OF THE INVENTION

Cards approximately the size of a credit card are very attractive media for transporting data. Because of their small size, they may be conveniently carried in a wallet or purse on the body of a person or mailed or otherwise easily transported. However, while cards of this size can be manufactured with substantial data storage capacity, their very convenience is also detrimental to their utility since dirt, grease, body oil, lint, etc., on the magnetic recording surface can seriously degrade the reproductivity of the data stored in the card.

The preferred embodiments of this invention provide a protection for the recording media without adversely compromising the readily portable nature of the storage card.

### BRIEF DESCRIPTION OF THE DRAWINGS

FIG. 1 is a perspective view of a storage card having two halves which, when closed, protect the recording media;

FIG. 2 is a is a top elevational view of another embodiment also employing two card halves;

FIG. 3 is a top elevational view of another embodiment of the invention also employing two card halves;

FIG. 4 is a top elevational view of an embodiment having a sequestered rotatable disk;

FIG. 5 is a top elevational view of an other embodiment of a sequestered rotatable disk; and

FIG. 6 is a pouch and card combination.

### DETAILED DESCRIPTION OF THE PREFERRED EMBODIMENTS

The preferred embodiments of this invention are directed to provide a recording surface on a credit card sized high-memory card when the card is in use, i.e., is being written to or read from by a suitable reader/writer, while when the card is not in use, protecting the recording surface from external contamination arising from handling or other exposure to dirt and/or abrasion that might impair the functionality of the recording medium.

The preferred embodiments of the protected high-memory card operate in the following manner. During their placement into a card/write reader under a read/write head mounted in or on a read/write control assembly, the normally-sequestered recording media is automatically uncovered by the card reader/writer, making it accessible to the read/write head. Upon completion of the read and/or write step, the process is reversed and the recording media is returned to its protected position, after which the card may be ejected from the card reader/writer.

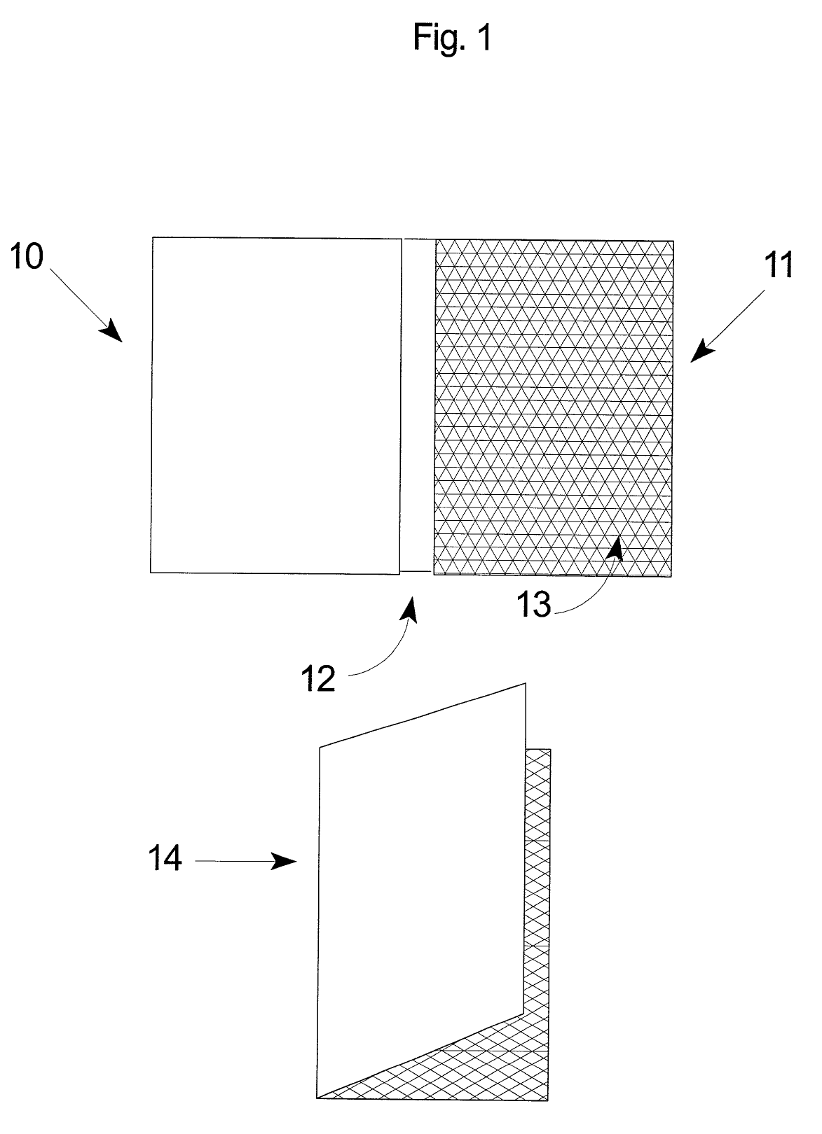

In one preferred embodiment of this sequestered recording media 14 and method shown in FIG. 1, the card is composed of two halves 10, 11 similar to the covers on a book, which halves are hinged along one edge 12 such that, upon their being opened by the apparatus, recording media 13 is exposed. This media may be applied to one or both internal sides. The recording media is placed beneath a read/write head for use, after which the two halves 10, 11 are again “closed” together and advantageously retained in a closed and locked position relative to each other by a suitable locking mechanism that is operated by insertion into and ejection from the card reader/writer.

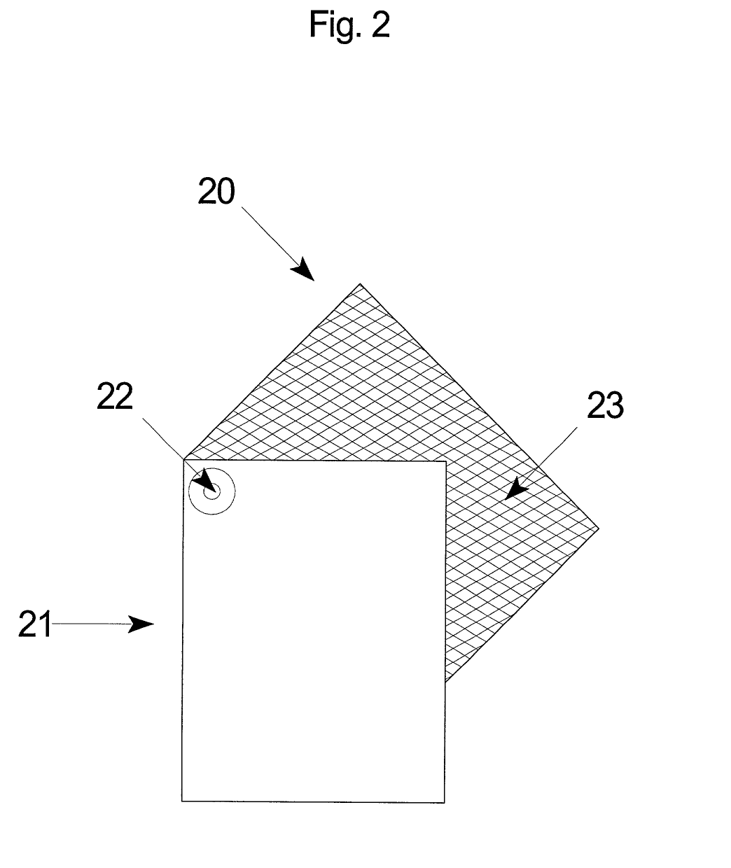

In another embodiment, illustrated in FIG. 2, the data storage card has two halves 20, 21 which together constitute the front and back of the card. Halves 20, 21 are joined at a corner by a hinge 22 that permits the halves to swivel, as in the action of a knife blade being opened, to an angle of as much as one hundred eighty degrees relative to each other, thus exposing the recording media 23 sequestered between halves 20, 21.

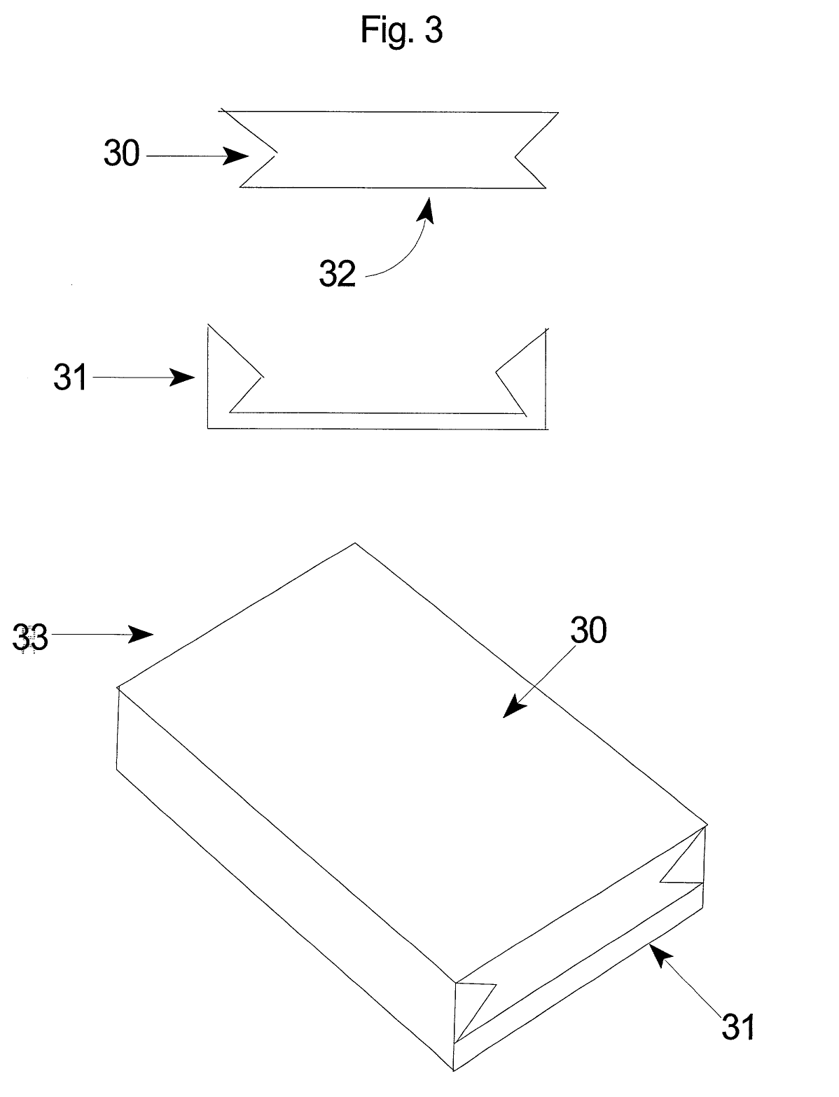

FIG. 3 shows another embodiment 33, having a top half 30 and a bottom half 31 respectively shown first in end view. The two halves 30, 31 are joined together by a method similar to tongue and groove joints, permitting the two halves 30, 31, once unlocked, to be slid either longitudinally or laterally relative to each other, thus exposing the normally sequestered recording media 32 for use. The relative thicknesses of the halves shown in FIG. 3 are exaggerated in size to clearly show the sliding joint structure.

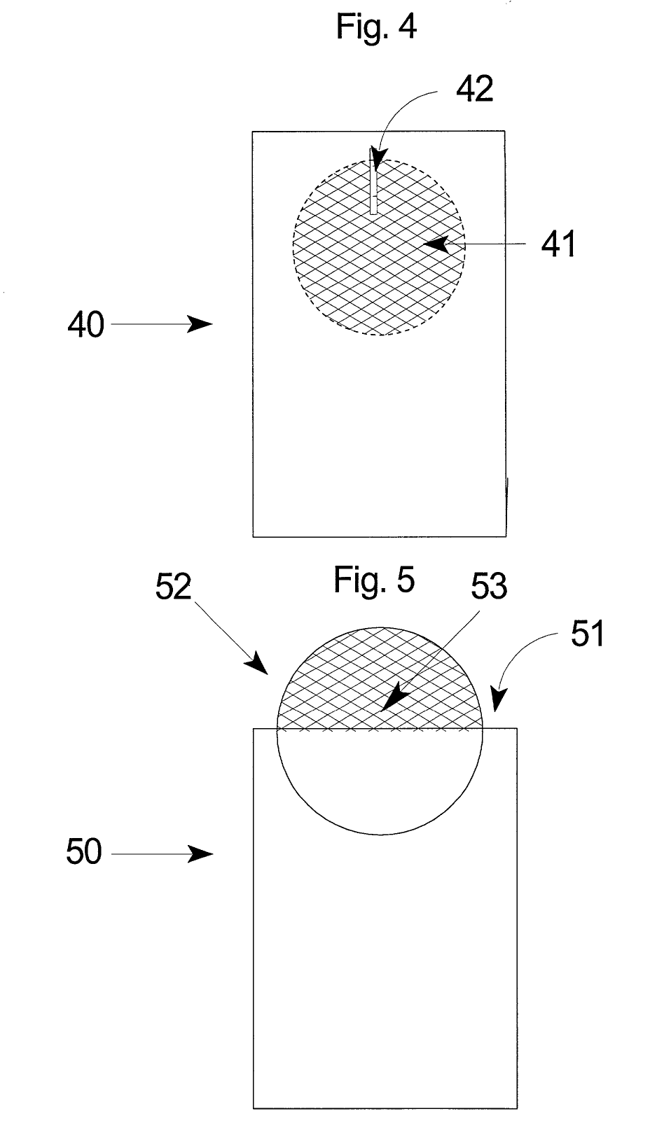

In another embodiment shown in FIG. 4, front and back halves of the card 40 are permanently bonded along their edges, and house between them a disk 41 of recording media 42 which rotates about an axis. The ends of this axis are secured in place to the inner walls of the card halves, permitting the disk of recording media to rotate the card halves. A motor in the reader/writer rotates the disk and the digital data is read from and written to the card through aperture 42 by a read/write head. The apertures 42 may be formed by a slot as shown. The slot may be in one or both of the cards. Closeable apertures (not shown) may also be used in one or in both sides of the card.

Illustrated in FIG. 5 is an embodiment 104, in which the front and back halves of the card 50 are permanently bonded along their edges with the exception of functional apertures 51 specifically left unbonded at the ends or sides of the card. The front and back halves of the card house between them a rotatable disk 52 of recording media 53 which rotates about an axis, the ends of which are movable along internal channels recessed into the inner walls of the card halves. This permits the disk of recording media to be slid out linearly by suitable apparatus in the card reader/writer. Up to half of the disk of recording media may be caused to project beyond the end or side of the card, whereupon it can, while being rotated by a motor in the card reader/writer, be read from and written to by one or more read/write heads placed over one side, or alternatively over both sides of the rotatable disk. In one specific embodiment, these heads are capable of being stepped radially along the exposed portion of the disk, after which the disk is then automatically retracted fully within the card halves for protection until its next use.

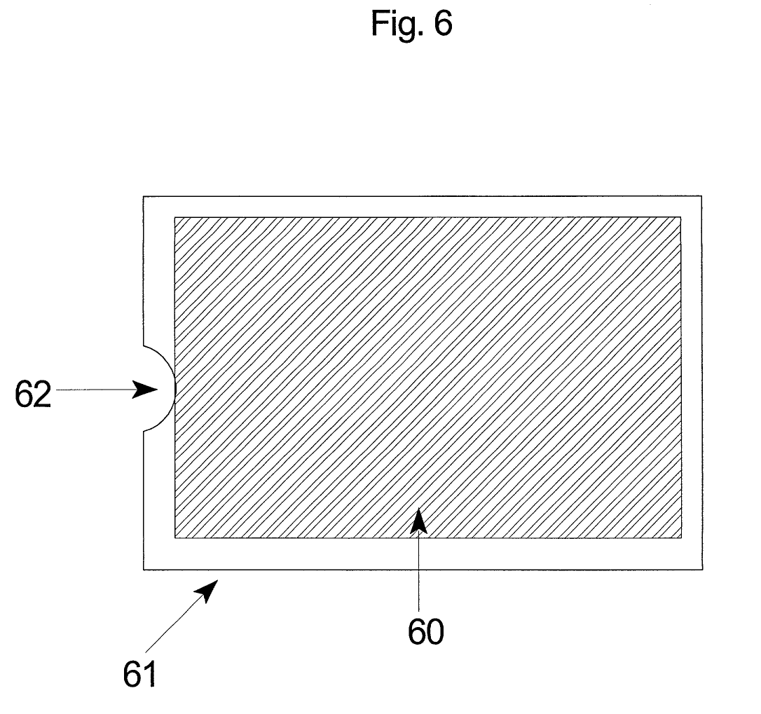

Any of the embodiments described above may be employed either separately or in conjunction with the use of a protective pouch or jacket in which the card is kept when not in use. In the embodiment shown in FIG. 6, a card 60 to which has been applied recording media on one or both external sides, is sequestered within a closeable pouch or jacket 61. Opening 62 provides for automatic removal or withdrawing of the card upon insertion of the card into a card reader/writer, thus permitting access to the magnetic recording media by a read/write head via access opening 62, following which the card, after use, is then automatically reinserted into access opening 62 by the protective pouch or jacket prior to ejection of the card from the reader/writer.

While the invention has been described herein with reference to certain preferred embodiments, these embodiments have been presented by way of example only, and not to limit the scope of the invention. Accordingly, the scope of the invention should be defined only in accordance with the claims that follow.

What is claimed is:

1. A protected data storage card approximately the size of a credit card so as to be small enough to be conveniently carried on a person's body or otherwise easily transported, said card having a recording surface upon which digital data can be written and/or read, said protected data storage card comprising:
a card having two halves;
magnetic recording media on one of said halves providing media on said recording surface;
the other of said halves having first and second positions, said first portion sequestering said magnetic recording media to protect said media against external contamination and said second position evaluating digital data to be being written or read from said card.

2. A protected data storage card approximately the size of a credit card so as to be small enough to be conveniently carried on a person's body or otherwise easily transported, said card having a recording surface upon which digital data can be written and/or read, said protected data storage card comprising:
a card having two halves;
said two halves having first and second positions relative to said recording surface, said first position sequestering said recording surface to protect against external contamination, and said second position automatically exposing said recording surface during the writing or reading of said digital data.

3. A protected data storage card comprising:
a card having two halves;
magnetic recording media on one side of one of said halves; and
a protective cover for said recording media.

4. The data storage card of claim 3, wherein said protective cover is provided by the other half of said card.

5. A protected data storage card comprising a card having two halves, and magnetic recording media sequestered by said halves for protecting said media against external contamination.

6. The protected data storage card of claim 5, wherein said halves fold together.

7. The protected data storage card of claim 5, wherein said halves are hinged along their length to open and fold similar to a book.

8. The protected data storage card of claim 5, wherein said halves are hinged at one corner to allow rotation of said halves in substantially the plane of said card.

9. The protected data storage card of claim 5, wherein said halves are joined by sliding connectors permitting the two halves to slide with respect to each other.

10. The protected data storage card of claim 5, wherein a rotatable disk carries said magnetic recording media.

11. The protected data storage card of claim 5, wherein the magnetic recording media on said disk is written or read through a closable aperture in one of said halves.

12. The protected data storage card of claim 11, wherein said aperture is closeable.

13. The protected data storage card of claim 5, wherein the magnetic recording media on said disk is written or read by sliding said disk partially out of said halves.

14. The protected data storage of claim 5, wherein a pouch covers said card, said pouch being withdrawn from all or part of said card to expose said magnetic recording media.

15. The method of protecting the magnetic recording surface of a magnetic data storage card approximately the size of a credit card comprising:
sequestering said magnetic recording surface between two halves of said data storage card, and
exposing said magnetic recording media within a card read or write apparatus.
